(19) United States
(12) Patent Application Publication
(10) Pub. No.: US 2004/0204958 A1
(43) Pub. Date: Oct. 14, 2004

(54) Electronic registration manager for business directory information

(75) Inventors: Gilma A.Z. Perkins, Redmond, WA (US); William J. Tutt, Bothell, WA (US); Chia-Chi Teng, Redmond, WA (US); Timothy E. Wood, Seattle, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/832,656

(22) Filed: Apr. 27, 2004

Related U.S. Application Data
(62) Division of application No. 09/650,605, filed on Aug. 30, 2000.

(51) Int. Cl. G06F 17/60

(52) U.S. Cl. 705/1

(57) ABSTRACT

A system and method providing electronic registration and maintenance of business directory listings and advertisements. In a computer system hosting an online business directory, it is advantageous to provide interested businesses with the ability to register their business listing information and/or advertisements such that the user may have direct input into the categorization the business listing(s) or advertisement(s) in the business directory. In an illustrative implementation, the system and methods of the present invention may be realized as an Internet based registration computing application cooperating with a business directory storing and displaying business directory listing information. This registration computing application may be employed as part of an Internet business directory listing information offering deployed on a Web site that offers business listing information services. The registration computing application may comprise a user interface to accept business listings and advertisement information from participating businesses, and instruction sets directed to the storage, maintenance, and modification of this information in a cooperating business directory listing data store.

### CROSS-REFERENCE TO RELATED APPLICATIONS

This application is a divisional of U.S. patent application No. Ser. 09,650,605, filed Aug. 30, 2000, now pending.

### FIELD OF THE INVENTION

The present invention relates to the field of business directory listings. Particularly to the procurement of business directory data, and more particularly, to an automated electronic system for the registration of businesses to be included in an online business directory listing service.

### BACKGROUND OF THE INVENTION

In today's ultra-competitive business climate, merchants, small and large, are constantly seeking new venues to showcase their products and services to keep a step on their competition. In this light, merchants are turning to advances in technology, hoping that they will provide competitive advantages. A recent advance contemplates using the Internet as a direct advertising medium in the form of business listings. Recently, merchants have begun to realize the impact of the Internet by listing their demographic information with Internet business directories in the hope of attracting consumers. Internet content providers, alike, have begun to accommodate merchants by offering comprehensive searchable business directories that list various demographic information about the merchant's business, including apportioned display space among their content so that merchants may place advertisements for their product or service.

However, online business directories, today, do not offer interested businesses user-friendly and efficient interfaces for the procurement of business directory listings and advertisements. That is, currently, an interested merchant is relegated to contacting a sales department of an Internet content provider via the phone or e-mail to place their business listing in an online business directory listing service. This process is inefficient, cumbersome, and may prove to be inaccurate. Additionally, the merchant is left to call the sales department any time they want to change or modify their existing business listing information. A more comprehensive and complete system and methods provide means and steps for automating the business listing registry process, allowing the interested merchant to choose the associations by which it wishes to be known and to have the opportunity to update such information at will. This system also provides significant benefits to Internet content providers, such as, automated collection of business listing fees and the reduction of their sales force previously dedicated to procuring such listings.

Online business directories typically provide business listing information and advertisements to participating users by categorizing the business listings and advertisements according to pre-defined or standardized categories. In presenting the business directory listing data according in such categories, the business directory listing information can more easily be searched. Inquisitive users trying to find a particular business listing may utilize these business directory listing categories to ferret out desired listings.

However, present day business directory listing and advertisement registration systems do not allow participating users to select the categories for the business listing information in the business directory. Stated differently, current business directory registration systems only offer users the ability to input keywords to describe their business. These keywords are processed and compared to a pre-defined list of categories by the business directory service to determine those categories to associate with the inputted business listing. In this process, the user is left out of the very important and vital categorization decision process. A more thorough electronic business directory listing registration system may offer the business directory listing categories (and sub-categories) to the user, giving users the opportunity to choose those categories that are most relevant to their business.

From the foregoing it can be appreciated that a need exists for efficient and user-friendly business directory listing electronic registration systems that allow interested businesses to list their businesses according to user selected categories, update existing listings, and pay for their business listings and advertisements.

### SUMMARY OF THE INVENTION

The present invention applies to a system and methods providing online registration of business listing information. The system may comprise a computing application that cooperates with a database. The database stores, among other items, business directory listing content. This business directory listing content may grouped, categorized, and referenced according to a predefined business listing data taxonomy that relates various business characteristics using various categorization schemes. In addition, the computing application may support a simple to use and manageable user interface that directs the user through a series of questions to procure a variety of demographic information about the business. Included in these questions may be directions to the user to pick relevant associations to their business. Stated differently, the user may be prompted to pick those categories from the business directory business data taxonomy with which the user wishes to associate the business. An aspect of the application allows the user to choose the category by viewing the business data taxonomy in canonical order or to perform a search for categories through a search dialog box. The business directory listing information may be stored and formatted according to business directory content schema in the cooperating database. Additionally, the user may include advertisement text or pictures that may be displayed when the business is queried for in the business directory. The computing application allows the user to update at will the inputted information about the business.

In an exemplary implementation, the online business listing registry system and methods are employed in the MSN Yellow Pages business directory for the automated registration and maintenance of merchant information.

### BRIEF DESCRIPTION OF THE DRAWINGS

The system and methods for the electronic registration of business listings and advertisements is further described with reference to the accompanying drawings in which:

FIG. 1 is a system diagram of is a block diagram representing a general purpose computer system in which aspects of the present invention may be incorporated;

FIG. 2 is a block diagram representing an exemplary network environment having computing elements in accordance with the present invention;

FIG. 3 is a block diagram of the interaction between a client computing devices and a server computing devices of exemplary computer network of FIG. 2 when procuring business directory listing related data in accordance with the present invention;

FIG. 3A is block diagram of an exemplary business data taxonomy employed by the electronic registration system and methods of the present invention;

FIG. 4 is a more detailed view of FIG. 3, showing the interaction among the various computing elements of a business listing registration system to communicate and store business directory listing information;

FIG. 5 is a block diagram of a an exemplary computing application for use in a business listing registration system in accordance with the present invention;

FIGS. 6-6D are screen shots of an exemplary computing application for use in the electronic registration of businesses in accordance with the present invention; and

FIG. 7 is a flowchart of the overall processing performed by the business listing registration system of FIG. 5 to list businesses;

FIG. 7A is a flowchart of the processing performed by the business listing registration system when creating a login user profile for participating users;

FIG. 7B is a flowchart of the processing performed by the business listing registration system when creating business listing contracts;

FIG. 7C is a flowchart of the processing performed by the business listing registration system when creating advertisement contracts;

FIG. 7D is a flowchart of the processing performed by the business listing registration system when matching a participating user with an archived business listing;

FIG. 7E is a flowchart of the processing performed by the business listing registration system when performing a search for an existing business in accordance with the processing of described in FIG. 7D;

FIG. 7F is a flowchart of the processing performed by the business listing registration system when performing contract saves; and

FIG. 7G is a flowchart of the processing performed by the business listing registration system when processing payments.

### DETAILED DESCRIPTION OF ILLUSTRATIVE EMBODIMENTS

Overview

The term “Internet” is an abbreviation for “Internetwork,” and refers commonly to the collection of networks and gateways that utilize the TCP/IP suite of protocols, which are well-known in the art of computer networking. TCP/IP is an acronym for “Transport Control Protocol/Interface Program,” a software protocol developed by the Department of Defense for communication between computers. The Internet can be described as a system of geographically distributed remote computer networks interconnected by computers executing networking protocols that allow users to interact and share information over the networks. Because of such wide-spread information sharing, remote networks such as the Internet have thus far generally evolved into an “open” system for which developers can design software applications for performing specialized operations or services, essentially without restriction.

Electronic information transferred between data-processing networks is usually presented in hypertext, a metaphor for presenting information in a manner in which text, images, sounds, and actions become linked together in a complex non-sequential web of associations that permit the user to “browse” or “navigate” through related topics, regardless of the presented order of the topics. These links are often established by both the author of a hypertext document and by the user, depending on the intent of the hypertext document. For example, traveling among links to the word “iron” in an article displayed within a graphical user interface in a data-processing system might lead the user to the periodic table of the chemical elements (i.e., linked by the word “iron”), or to a reference to the use of iron in weapons in Europe in the Dark Ages. The term “hypertext” was coined in the 1960s to describe documents, as presented by a computer, that express the nonlinear structure of ideas, as opposed to the linear format of books, film, and speech.

The term “hypermedia,” on the other hand, more recently introduced, is nearly synonymous with “hypertext” but focuses on the non-textual components of hypertext, such as animation, recorded sound, and video. Hypermedia is the integration of graphics, sound, video, or any combination thereof into a primarily associative system of information storage and retrieval. Hypermedia, as well as hypertext, especially in an interactive format where choices are controlled by the user, is structured around the idea of offering a working and learning environment that parallels human thinking—that is, an environment that allows the user to make associations between topics rather than move sequentially from one to the next, as in an alphabetic list. Hypermedia, as well as hypertext topics, are thus linked in a manner that allows the user to jump from one subject to other related subjects during a search for information. Hyper-link information is contained within hypermedia and hypertext documents, which allow a user to move back to “original” or referring network sites by the mere “click” (i.e., with a mouse or other pointing device) of the hyper-linked topic.

A typical networked system that utilizes hypertext and hypermedia conventions follows a client/server architecture. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computer that accesses shared network resources provided by another computer (i.e., a server).

A request by a user for news can be sent by a client application program to a server. A server is typically a remote computer system accessible over a remote network such as the Internet. The server scans and searches for raw (e.g., unprocessed) information sources (e.g., newswire feeds or newsgroups). Based upon such requests by the user, the server presents filtered electronic information as server responses to the client process. The client process may be active in a first computer system, and the server process may be active in a second computer system, communicating with one another over a communications medium, thus providing distributed functionality and allowing multiple clients to take advantage of the information-gathering capabilities of the server.

Client and server communicate with one another utilizing the functionality provided by Hypertext-Transfer Protocol (HTTP) or the Wireless Application Protocol (WAP). The World Wide Web (WWW) or, simply, the “Web,” includes those servers adhering to this standard (i.e., HTTP and WAP) which are accessible to clients via a computer or data-processing system network address such as a Universal Resource Locator (URL). The network address can be referred to as a Universal Resource Locator address. For example, communication can be provided over a communications medium. In particular, the client and server may be coupled to one another via Serial Line Internet Protocol (SLIP) or TCP/IP connections for high-capacity communication. Active within the client is a first process, known as a “browser,” which establishes the connection with the server and presents information to the user. The server itself executes corresponding server software which presents information to the client in the form of HTTP responses. The HTTP responses correspond to “web pages” constructed from a Hypertext Markup Language (HTML), Hand-held Device Markup Language (HDML), Extensible Markup Language (XML), or other server-generated data. Each web page can also be referred to simply as a “page.”

The client and server typically display browsers and other remote network data for a user via a graphical user interface. A graphical user interface is a type of display format that enables a user to choose commands, start programs, and see lists of files and other options by pointing to pictorial representations (icons) and lists of menu items on the screen. Choices can be activated generally either with a keyboard or a mouse. Internet services are typically accessed by specifying a unique network address (i.e., Universal Resource Locator). The Universal Resource Locator address has two basic components, the protocol to be used and the object pathname. For example, the Universal Resource Locator address, “http://www.uspto.gov” (i.e., home page for the U.S. Patent and Trademark Office), specifies a hypertext-transfer protocol (“http”) and a pathname of the server (“www.uspto.gov”). The server name is associated with a unique numeric value (TCP/IP address).

The immense popularity of the Internet among consumers has driven Internet content providers to deliver distinguishing products and services. A key service offering provides businesses with the ability to list their information about their business in an expansive and far reaching online business directory. However, current online business directories provide little control to participating businesses over the manner in which their business information is listed and, more importantly, how their business information is categorized. That is, online business directories generally list businesses according to SIC (Standard Industry Code) classifications. These SIC classifications are broad and generic, providing little assistance, if any, to querying consumers in ferreting out desired businesses.

The present invention was developed to provide adaptable automated registration of business listings. A computing application may be provided to guide interested businesses through the registration and payment for a business listing in an Internet based business directory service. The electronic business listing registration system and methods are contemplated for use by an Internet service providing business directory listing content to a variety of computing devices. The electronic business listing registration system and methods enables an online business directory service offering to more easily procure, manage, and maintain business listing information. Direct results of the efficiencies provided by the present invention may be most recognized by an increase in sales.

The electronic business listing registration system enables businesses to have direct control over the business listing content and display. Specifically, the registration system allows businesses to specify what business data will be included in the online business directory listing, and moreover, to specify the categorization of the business data. Furthermore, the participating business is afforded the ability to choose and modify advertisement packages. Included with this option, is the ability to choose the characteristics and content of the advertisements (e.g. the participating business is afforded the ability to upload graphic tile and banner image files) that are associated with the business listing data. The business may also select the market(s) in which the business listing information and/or advertisements will be displayed. This system benefits online business directory operators by allowing operators the ability to specify contract terms for the business listing service, and furthermore, to accept online payment (i.e., via credit card) for the fees associated with the listing of the business information and advertisements.

Further, the registration system of the present invention evolves the conventional advertising model of online business directories by creating a new, automated sales process. The new process is self-service, requiring no manual touch points, thereby freeing up valuable labor resources. This will result in faster, more efficient means for creating, modifying and renewing online advertising for both existing and newly created business listings. Such improvements may prove to be important distinguishing features that provide business directory operators sought after competitive advantages. These advantages may be realized as more advertisers employ this automated process to display their advertisements.

Generally, advertising packages are comprised of graphical enhancements (i.e., graphic tiles or banners) associated with business listings data and/or links to a business' Web sites. By using the registration system and methods of the present invention, businesses are allowed to modify their advertising content, thereby delivering more accurate and timely information to their customer base. An important step when creating advertising for online business directories is associating the ad components with the correct business listing. It is not uncommon that an online business directory contain over ten million business listings, rendering the task of associating advertisements to business listings as rather daunting. The registration system walks the participating business through the necessary steps to identify their business, if the business already has a listing in the business directory. Alternatively, if the business does not already exist in the business directory, the present invention will create a new business listing.

Prior to this invention, the original contract process for procuring and displaying business listing and advertising content required the expenditure of significant resources. These resources included, sales personnel in the field to receive new listings; direct contact between sales personnel and interested businesses; additional business processes involving mounds of paperwork; and an advertisement/business listing production team to enter data, including new business listings and advertisement attributes. Not surprisingly, this process results in a two week turn-around time from whence the contract was signed until the listing or advertisement was displayed in the online business directory. The present invention eliminates most of these required resources, freeing them for use elsewhere and reducing the turn around time to approximately one day.

In an illustrative implementation, the electronic business listing registration system may be realized as a computing application employed by an Internet based business directory business listing and advertisement service to procure, manage, and maintain business listings and advertisements. This computing application may support a number of scenarios. For example, the registration system can accommodate businesses that wish to provide new listings or advertisements. In this case, an interested business may navigate their Web browser computing application to the Internet based business directory and provide location, categorization, and advertisement information for listing in the business directory service. Comparatively, the computing application may be used by businesses that already have contracts for the listing of advertisements and business listing information but wish to add additional listing information or advertisements. The system also allows renewals of existing contracts. In the case a business' contract is no longer active or about to expire, the business may employ the system to update their contract status and select additional business listing information or advertisement content. Furthermore, the exemplary computing application may accept a variety of payment methods from users to pay for the business listings and advertisements.

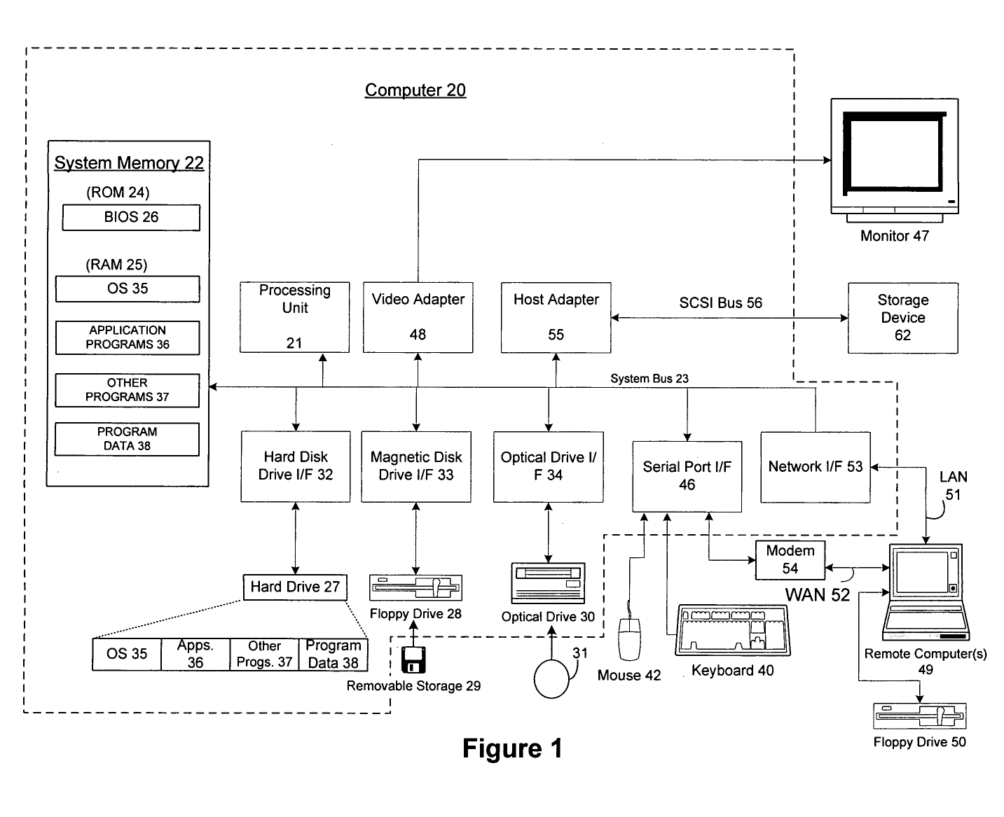

As will be described below with respect to FIGS. 1-7G, the present invention is directed to a system and methods for the electronic registration, management, and maintenance of business directory listings and advertisements. In accordance with an illustrative implementation thereof, the present invention comprises a system and method to provide interested businesses with a user-friendly application for the electronic registration of business listings and advertisements.

In one embodiment, described more fully hereinafter, the methods and apparatus of the present invention may be implemented as part of a computer network such as the Internet having a plurality of server computers representing Internet content providers hosting content, such as Internet domains. Further, a plurality of users (i.e., client computers) are connected to the computer network through computer hardware and software (i.e., Web browsers) such that the user may request, transmit, and receive Internet content. Although the depicted embodiment provides an Internet based computing application for the registration of business listings and advertisements, those skilled in the art will appreciate that the inventive concepts described herein extend to electronic business listing and advertisement registration systems and methods deployed on various computing systems having a variety of configurations.

Illustrative Computing Environment

FIG. 1 and the following discussion are intended to provide a brief general description of a suitable computing environment in which the invention may be implemented. Although not required, the invention will be described in the general context of computer-executable instructions, such as program modules, being executed by a computer, such as a client workstation or a server. Generally, program modules include routines, programs, objects, components, data structures and the like that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 1, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system 26 (BIOS), containing the basic routines that help to transfer information between elements within the personal computer 20, such as during start-up, is stored in ROM 24. The personal computer 20 may further include a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide non-volatile storage of computer readable instructions, data structures, program modules and other data for the personal computer 20. Although the exemplary environment described herein employs a hard disk, a removable magnetic disk 29, and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read-only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner, or the like. These and other input devices are often connected to the processing unit 21 through a serial port interface 46 that is coupled to the system bus, but may be connected by other interfaces, such as a parallel port, game port, or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets, and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

Illustrative Computer Network Environment

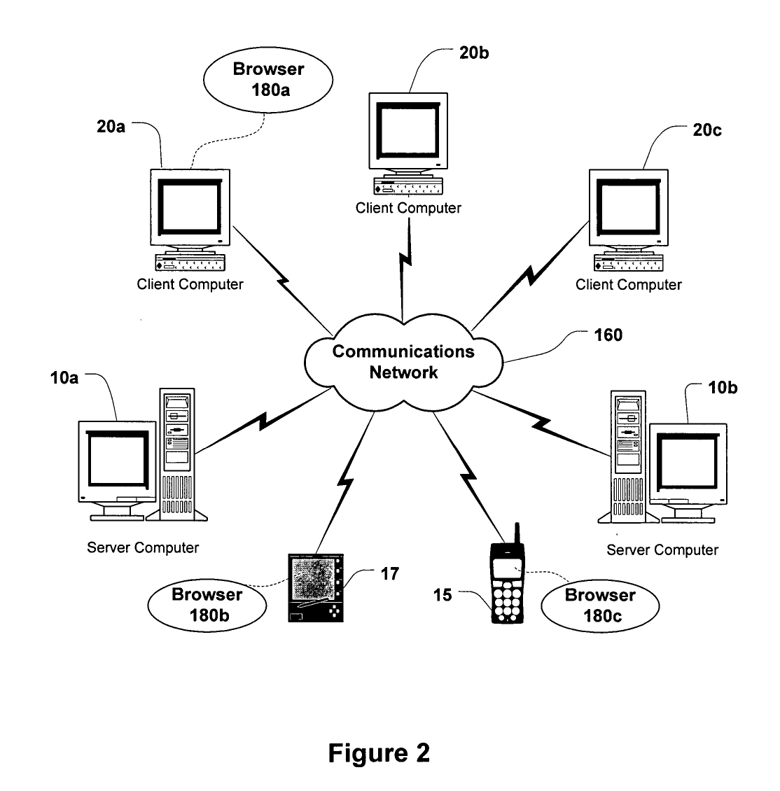

As noted, the computer described above can be deployed as part of a computer network. In general, the above description applies to both server computers and client computers deployed in a network environment. FIG. 2 illustrates an exemplary network environment, with a server in communication with client computers via a network, in which the present invention may be employed. As shown in FIG. 2, a number of servers 10a, 10b, etc., are interconnected via a communications network 160 (which may be a LAN, WAN, intranet or the Internet) with a number of client computers 20a, 20b, 20c, or computing devices, such as, mobile phone 15 and personal digital assistant 17. In a network environment in which the communications network 160 is the Internet, for example, the servers 10 can be Web servers with which the clients 20 communicate via any of a number of known protocols, such as, hypertext transfer protocol (HTTP) or wireless application protocol (WAP). Each client computer 20 can be equipped with browser 180a to gain access to the servers 10. Similarly, personal digital assistant 17 can be equipped with browser 180b and mobile phone 15 can be equipped with browser 180c to display and receive various data.

Thus, the present invention can be utilized in a computer network environment having client computing devices for accessing and interacting with the network and a server computer for interacting with client computers. However, the systems and methods for providing the electronic registration and maintenance of business directory listings and advertisements of the present invention can be implemented with a variety of network-based architectures, and thus should not be limited to the example shown. The present invention will now be described in more detail with reference to a presently illustrative implementation.

Electronic Business Directory Listing Registration Systems and Methods

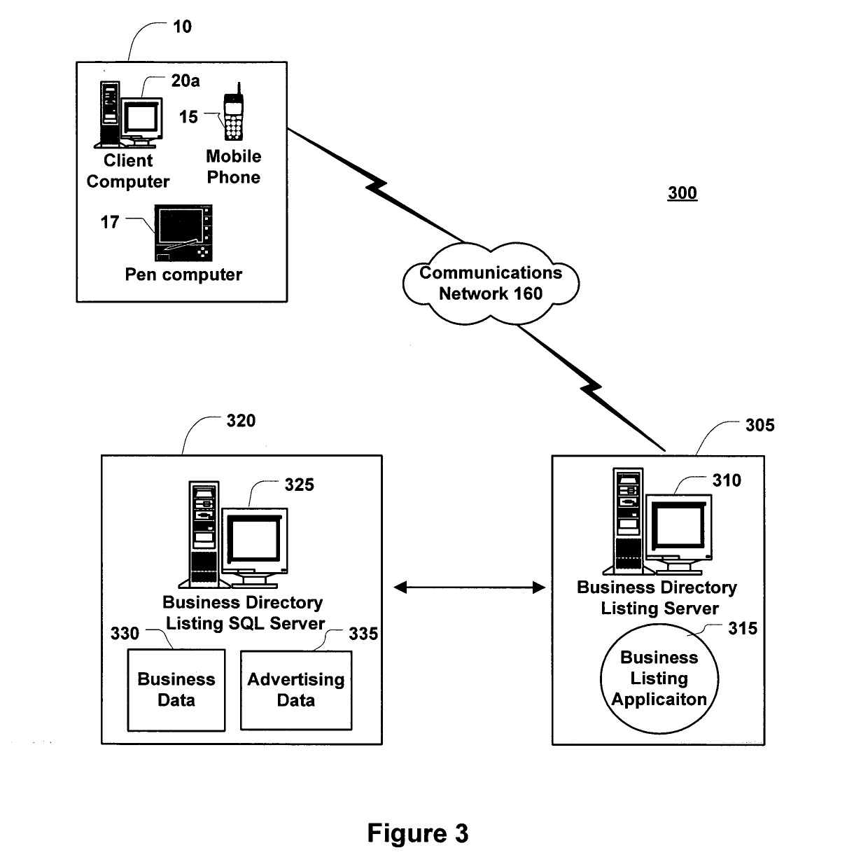

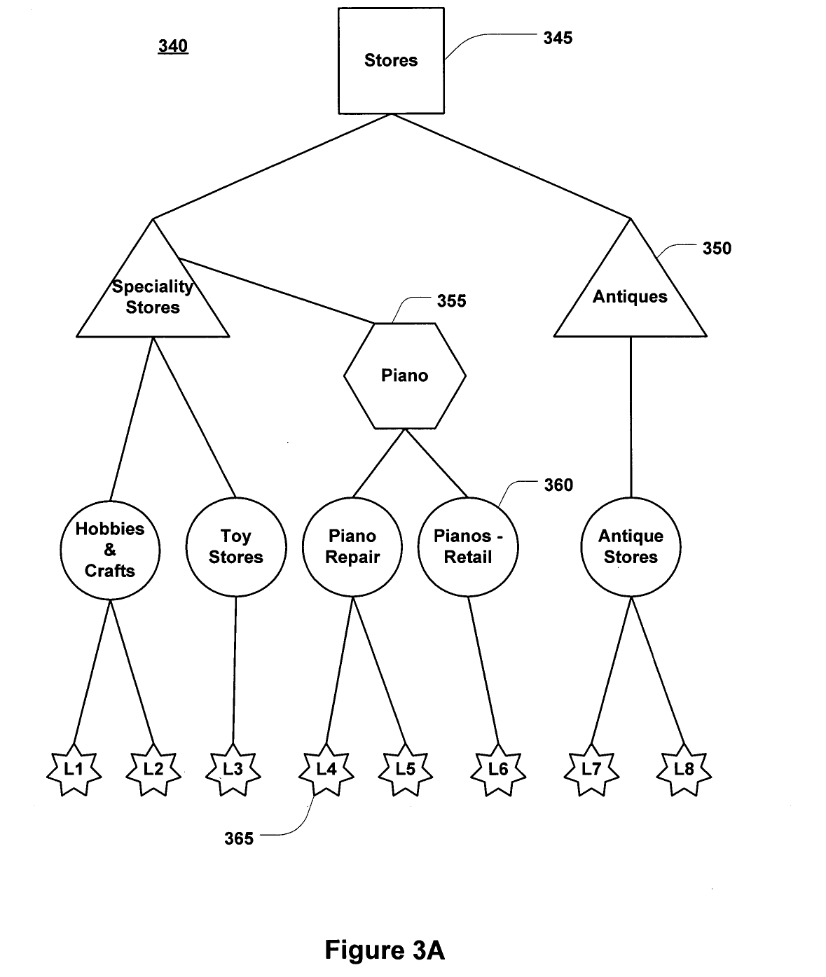

FIG. 3 shows business directory listing electronic registration system 300 comprising, registration engine 305 and business directory listings data store 320. Users group 10 may comprise a variety of computing devices, such as, client computer 10a, mobile phone 15, or personal digital assistant 17. Registration engine 305 may comprise a business directory listing server 310 maintaining listing registration application 315. Furthermore, FIG. 3 shows business directory listing data store as comprising a business directory listing SQL server 325 housing business data 330 and advertising data 335.

In operation, a member of requesting computing devices group 10, such as, client computer 10a, mobile phone 15, or personal digital assistant 17, may electronically register business listings and advertisements with business directory listing data rendering system 300 by transmitting a request to registration engine 305 over communications network 160. In turn, registration engine 305 may cooperate with business directory listing data store 320 to store and retrieve content when processing business listings and advertisement registrations. Business directory listing server 310 of registration engine 305 may execute listing registration application 315 to procure, maintain, and store business listing and advertisement information in accordance with registration requests from computing devices group 10. As part of the operation of listing registration application 315, business directory listing server 310 may cooperate with business directory listing data store 320. Specifically, business directory listing server 310 may store or retrieve from business directory listing SQL server 325 of business directory listing data store 320 relevant content to satisfy the received request. In turn, business directory listing SQL server 325 may store and/or retrieve relevant business data 330 and advertising data 335 for cooperation with business directory listing server 310.

Employing, listing registration application 315, business directory listing server 310 may provide business data 330 and advertising data 335 in accordance to a predefined layout that can be displayed on the requesting computing device. The data may be passed to client computing devices 10 over communications network 160. In an illustrative implementation, the business directory listing registration system may be employed by the MSN Yellow Pages (YP) business directory listing service to procure, maintain, and store business listings and advertisements.

FIG. 3A shows an example business directory listing taxonomy 340 of business directory listing data that may be maintained by business directory listing data store 320 of FIG. 3. Data taxonomy 340 has various levels 345 (top level), 350 (second level), 355 (third level), 360 (leaf nodes), and 365 (directory listing level). These levels are related in such a manner that data residing in level 345 acts as a parent to data found in level 350. Similarly, data that resides in level 350 may act as parents to data found in level 355 or data found in level 360. Accordingly, data found in level 365 may be children of data found in level 360. As shown, each of the various levels may contain a number of data elements. When implemented the lowest level 365 may contain the actual business directory listing information. Correspondingly, level 360, the parent to data of level 365, may serve to categorize the business directory listing information (ABISIC base directory listings) according to editorialized detailed category designations. Similarly, level 355 may serve to provide broader category designations for category designations of level 360. Level 350 may provide even broader categorization for data found in levels 355 or 360. Lastly, level 345 may provide the broadest category designations for data of level 350.

Data taxonomy 340 is better described by the following example. For example, level 340 may provide the broad category designation of “stores”. Within this category designation, therein may exist more specific categories, such as, “specialty stores” and “antiques” found in level 350. Further “specialty stores” may encompass more specific categories, such, as “piano” stores as found in level 355 or alternatively “hobbies & crafts” and “toy stores” found in level 360. The “piano” stores category description of level 355 may act to broadly describe more specific categories “piano repair” and “pianos-retail” stores of level 360. Similarly, the “antiques” category descriptor of level 350 may act to describe the more specific category of “antique stores” of level 360. In turn, “antique stores” may act as a parent or category descriptor for business listings L7 and L8 of level 365. Similarly category descriptors “hobbies & crafts”, “toy stores”, “piano repair” and “pianos retail” may serve as category descriptors of ABISIC base business listings L1 and L2, L3, L4 and L5, and L6, respectively.

In operation, data taxonomy is utilized by business directory listing registration system 300 (of FIG. 3) to offer participating users a comprehensive categorization scheme for the categorization of business listings and advertisements. In having the data stored according to this exemplary taxonomy, business listings may be better classified to facilitate future retrieval by users searching the business directory. The various levels within the taxonomy allow for the existence of various associations among the data such that searches may be performed to capitalize on these associations.

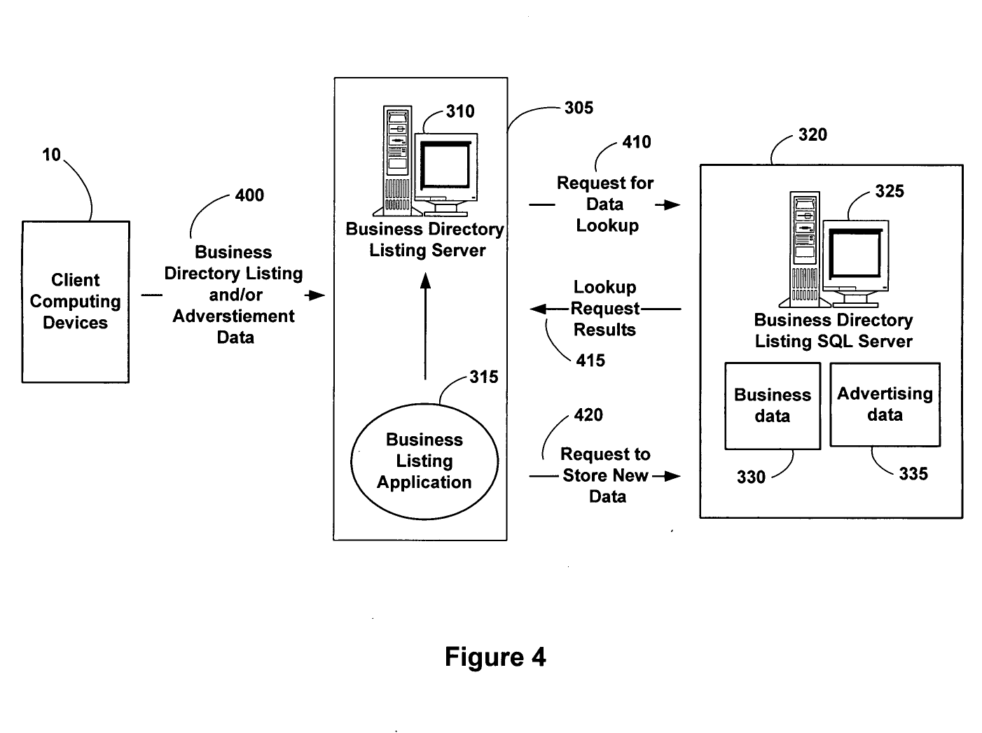

FIG. 4 shows the interaction between the cooperating components of business directory listing registration system 300 of FIG. 3. As shown, client computing devices 10 may send business directory listing and/or advertisement data 400 to registration engine 305. In response, business directory listing server 310 of registration engine 305 may process the data according by executing listing registration application 315 and send a request for data lookup 410 to business directory listing store 320. Request for data lookup 410 is employed to determine if the requesting user (not shown) has business listing or advertisement information already stored in business directory data store 320. Business directory data store 320 may process request for data lookup 410 and return lookup request results 415 to registration engine 305. Included in lookup request results 415 may be business listing and advertisement information stored in business directory data store 320 for the participating user (not shown). Listing registration application 315 of registration engine 305 may process lookup request results 415 to determine which additional information to request from client computing devices 10. In turn, client computing devices 10 may offer new or updated business listing information to listing registration application 315. Accordingly, listing registration application 315 may offer a request to store new or updated data 420 to store the new or updated business listing information in business listing data store 320.

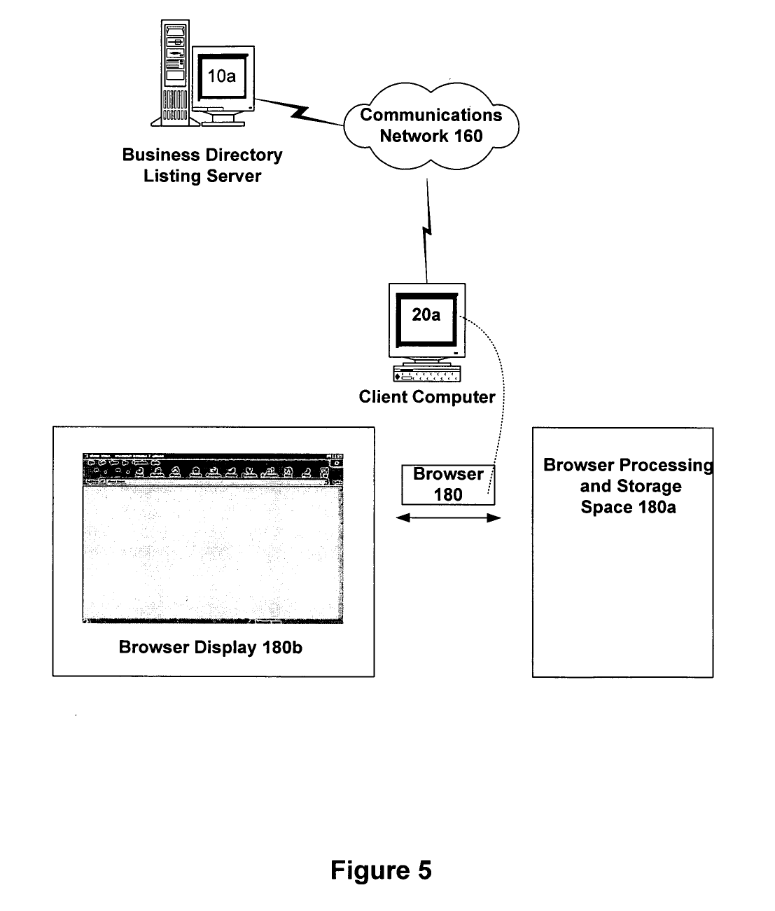

FIG. 5 shows an exemplary computing application running on client computer 20a that allows a user to interact with registration engine of FIG. 3. As shown, client computer 20a may communicate information to and from business directory listing server 10a over communications network 160. This information may be transmitted and displayed through browser 180. Browser 180 comprises browser processing and storage space 180a and browser display area 180b. In operation, data may be communicated to client computer 20a for processing and display to a participating user (not shown) from business directory listing server 10a through communications network 160. The data may be processed by browser 180 in browser processing and storage space 180a and displayed in browser display 180b to a cooperating user (not shown). Business directory listing registration system 300 of FIG. 3 may utilize browser 180 to display interfaces to procure and display various information from and to participating users when processing the registration of business listings and advertisements.

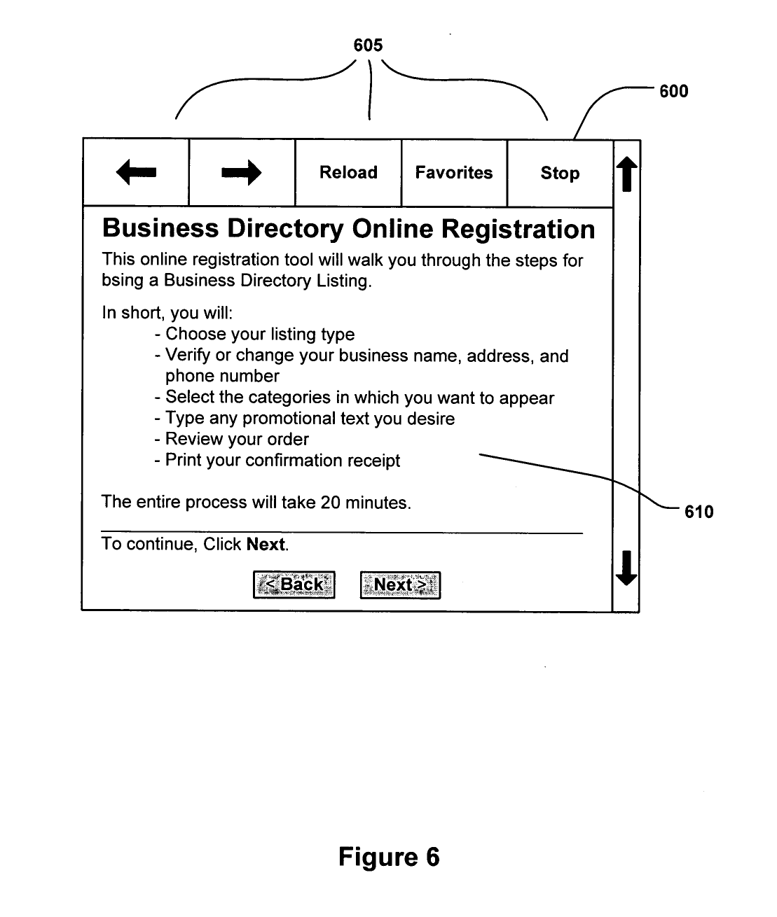

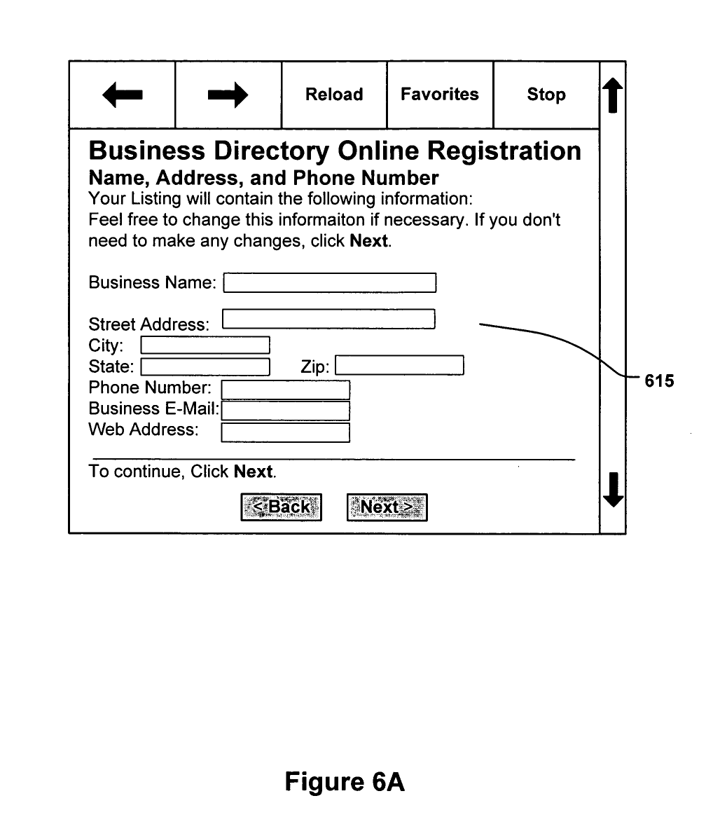

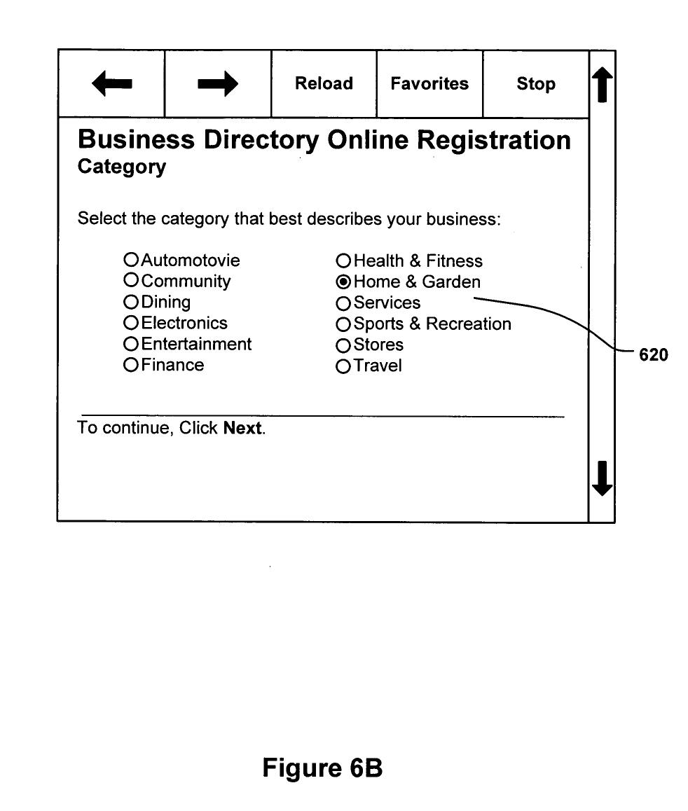

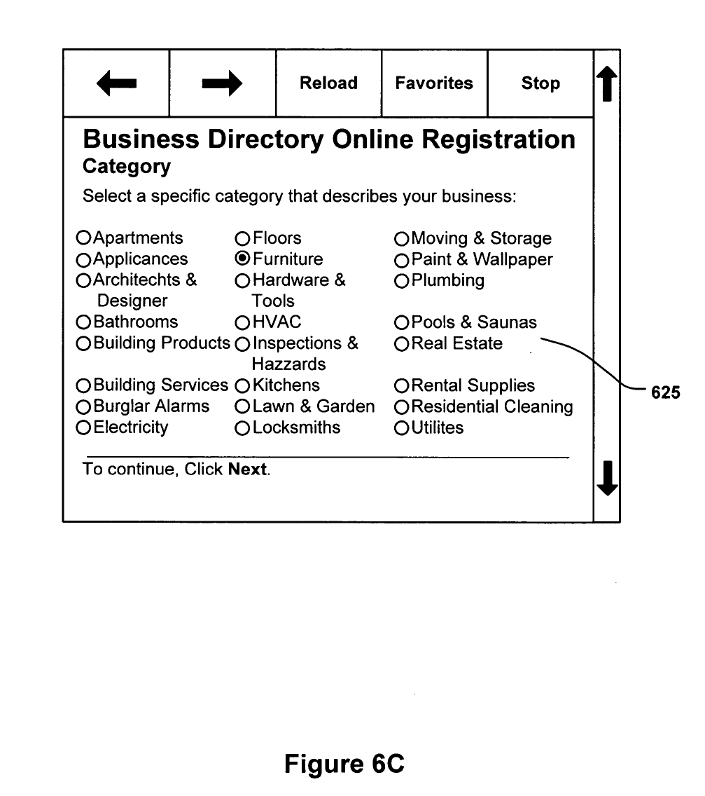

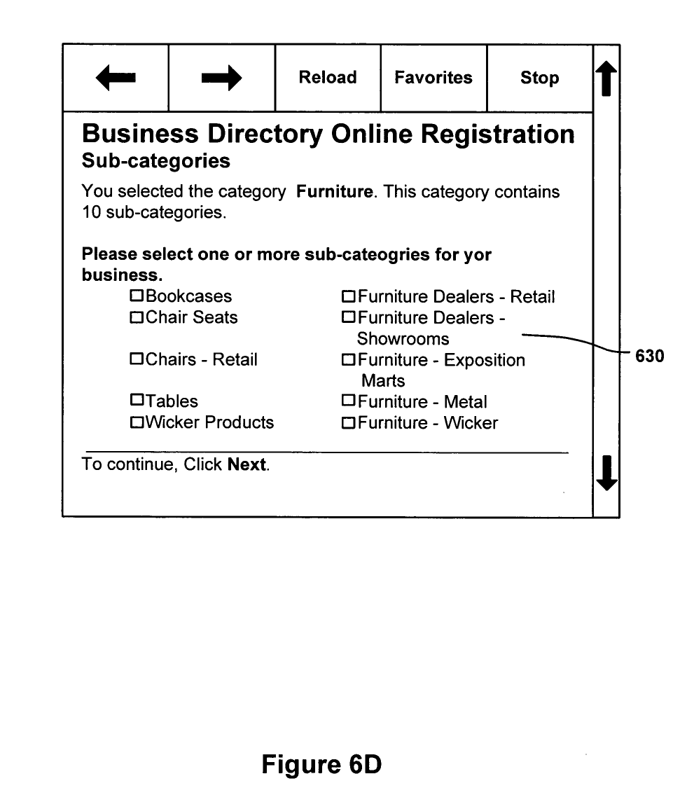

FIGS. 6-6E shows screen shots of exemplary computing application 180 of FIG. 5 processing and displaying data in accordance with business directory listing registration system 300 of FIG. 3. As shown in FIG. 6, computing application 180 may be displayed as application pane 600 offering a cooperating user (not shown) various controls to navigate and manipulate content 610. In the implementation illustrated, content 610 comprises an introductory page of a Web site offering to participating users online registration of business directory listings and advertisements. The registration service allows users to choose, among other things, a listing type; verify or change an already listed business name, address, or phone number; select the categories in which the participating user chooses to be associated with; and the ability to include promotional text to the business listing.

FIG. 6A shows a screen shot comprising business demographic content 615 for use by illustrative registration application of FIG. 6. As illustrated, demographic content 615 may comprise data input fields prompting participating users (not shown) to input, among other things, the following information, business name, street address, city, state, phone number, business e-mail, and web-address.

FIG. 6B shows a screen shot comprising category content 620 for use by participating users (not shown) to categorize their business listings and advertisements according to user preferred categories. The categories listed in category content 620 may directly relate to various higher level descriptions of data taxonomy 340 of FIG. 3A. Similarly, FIG. 6C shows a screen shot comprising category content 625 listing sub-categories that may be related to the category chosen in FIG. 6B by participating users (not shown). Participating users (not shown) may choose all of these sub-categories from category content 625 to better classify their business listings. Akin to FIG. 6B, the sub-categories of FIG. 6C may directly relate to lower level descriptions of data taxonomy 340 of FIG. 3A. FIG. 6D shows yet another screen shot comprising additional sub-category content 630. Sub-category content 630 comprises further classification offerings to participating users to better define their business. The sub-categories listed may directly relate to lower level descriptions of data taxonomy 340 of FIG. 3A. FIG. 6E shows an alternative manner by which participating users may categorize their business listings. As shown, the application pane of FIG. 6A comprises content 635 which includes a search dialog box that allows users to search for those categories (as opposed to selecting from a pre-defined list of categories) to be used to classify their business listings.

In operation, participating users (not shown) may choose those categories from category content 620, 625 or 630, or, in the alternative, search for categories using keywords according to content 635, that best define their business listing. For example, as shown in FIGS. 6B-6D, a participating user may offer a business listing for furniture related items. Accordingly, the user may choose the “Home and Garden” category classification from content 620 of FIG. 6B, the “Furniture” category from content 625 of FIG. 6C, and “Bookcases and Tables” from sub-category content 630. Alternatively, the user may reach the same results by searching for these categories and sub-categories according to content 635.

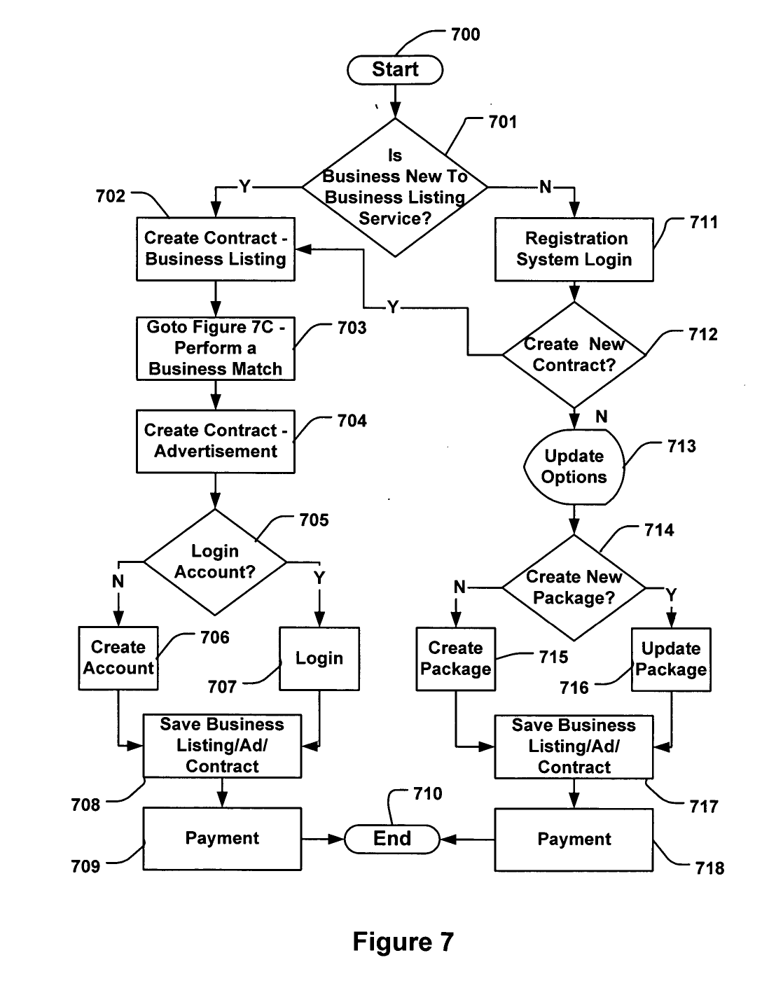

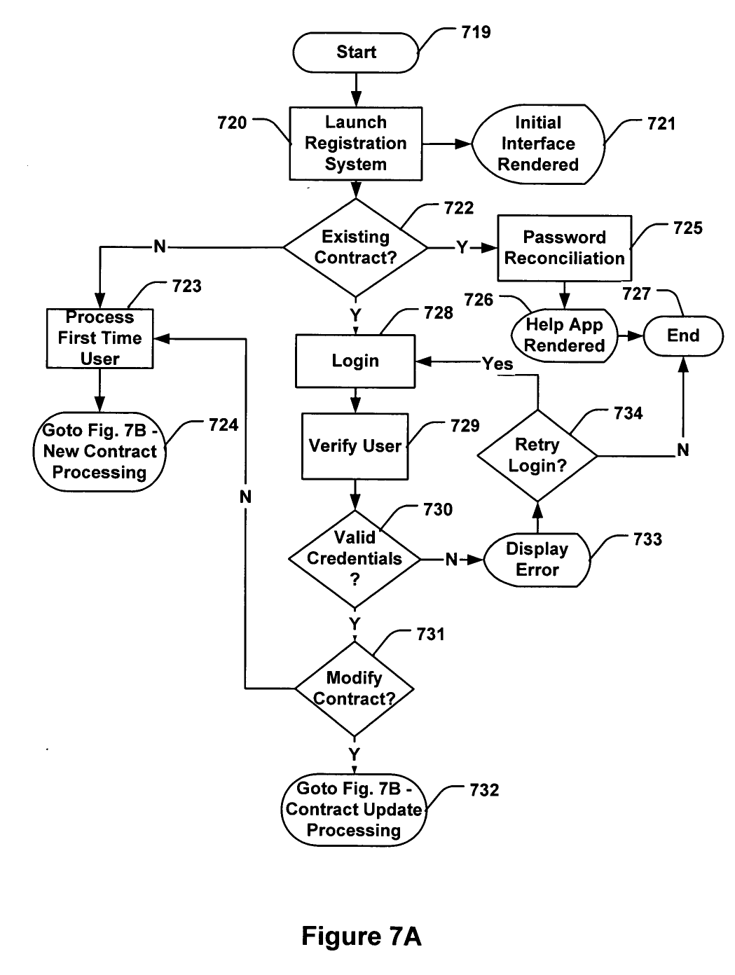

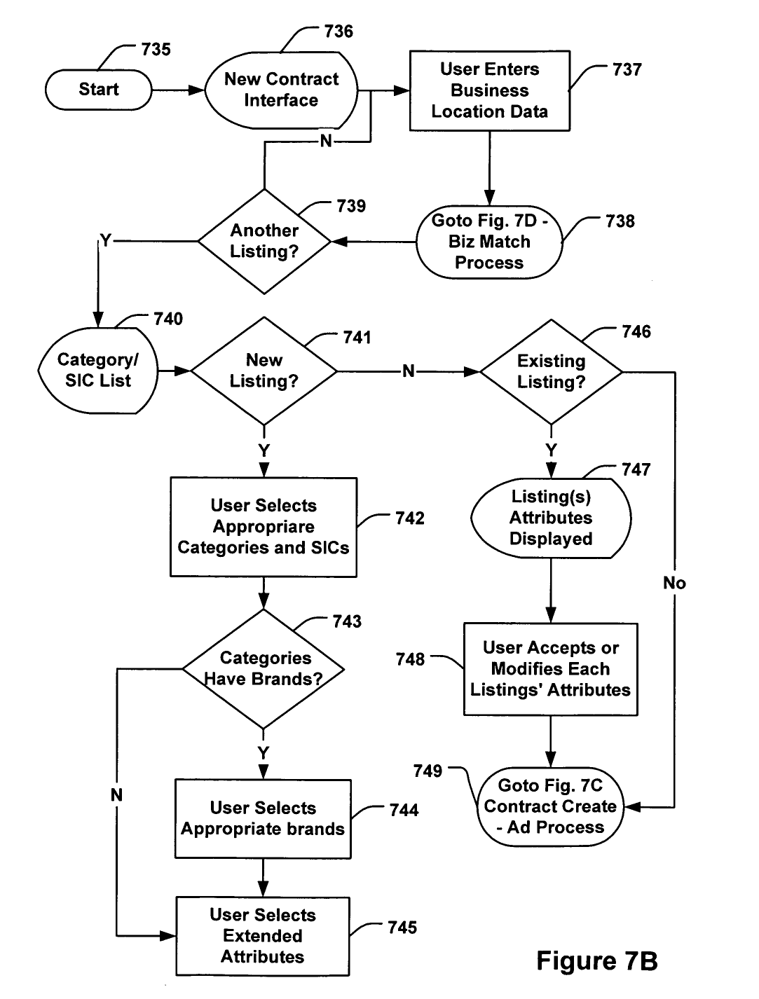

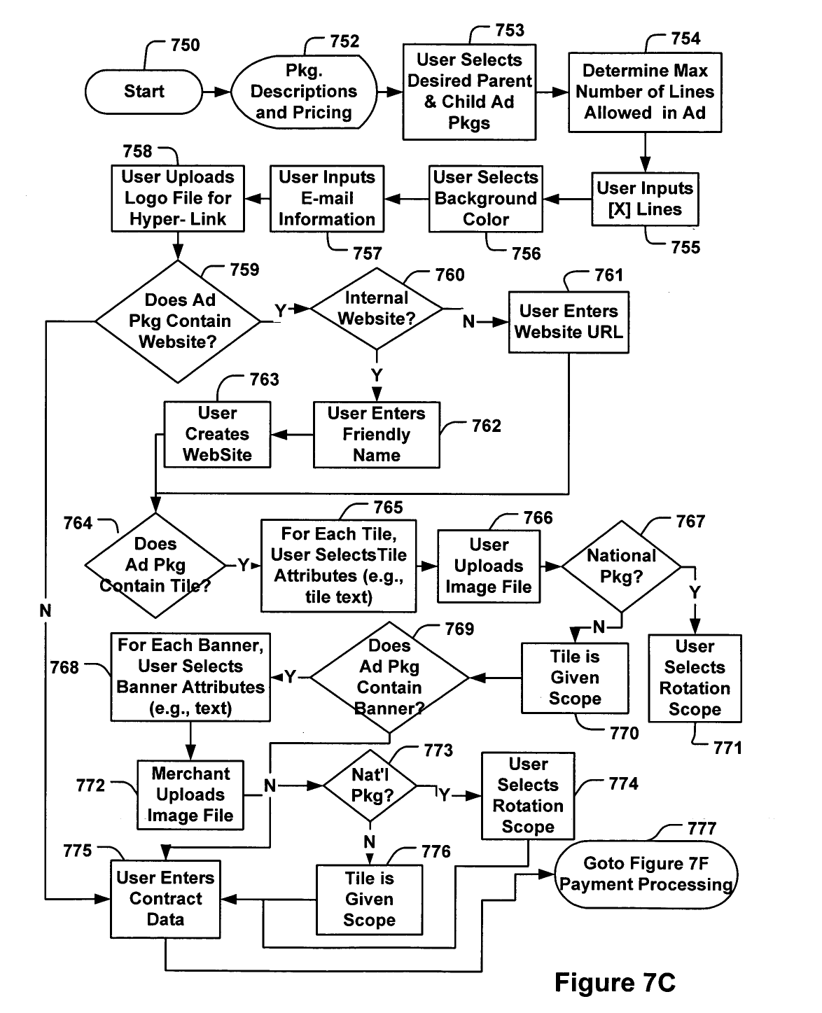

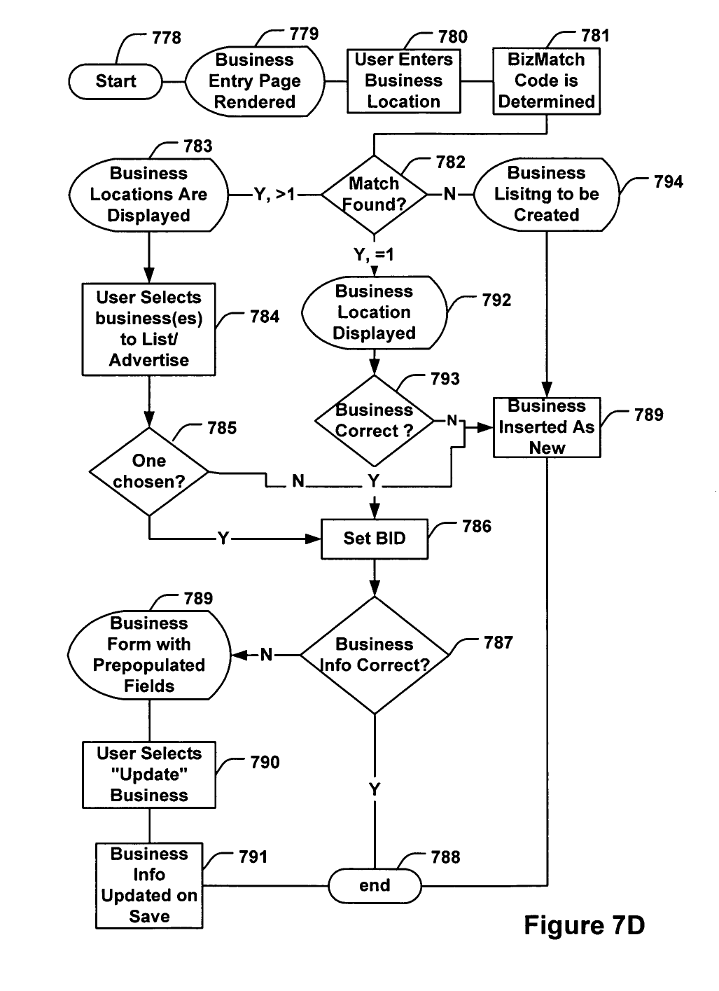

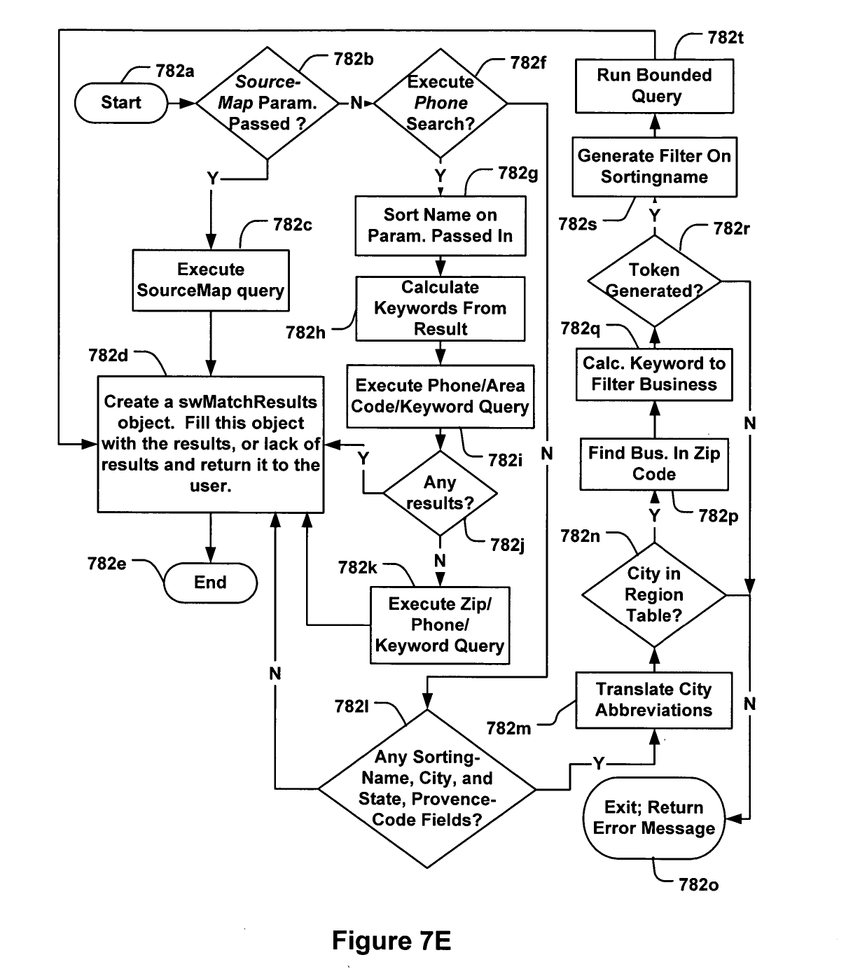

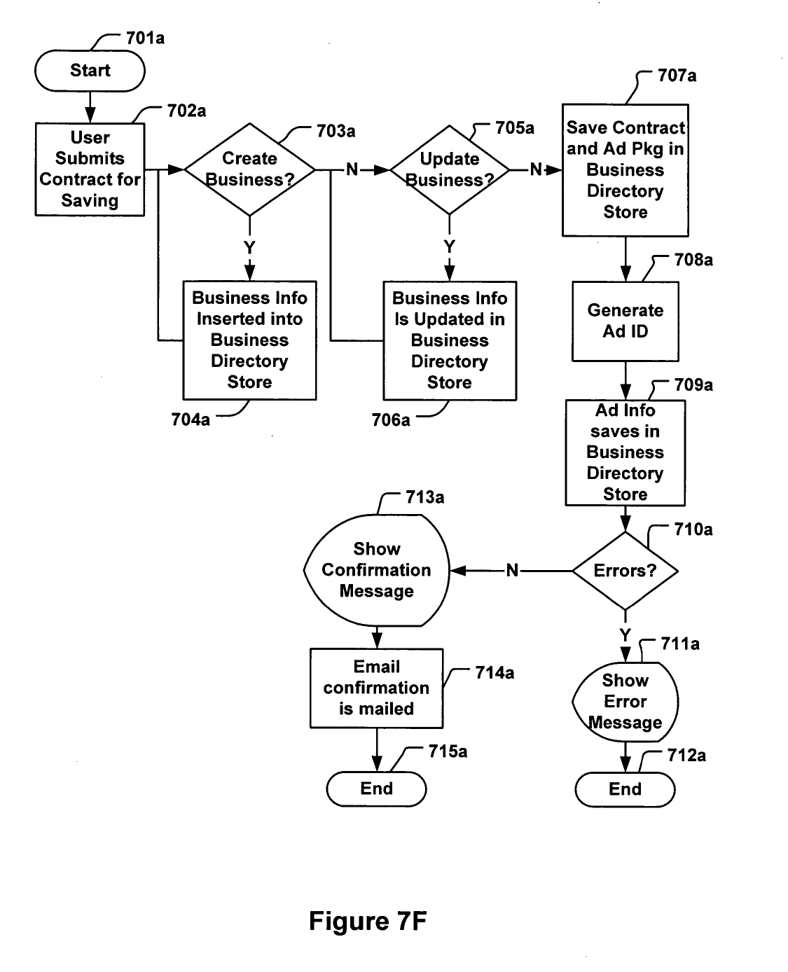

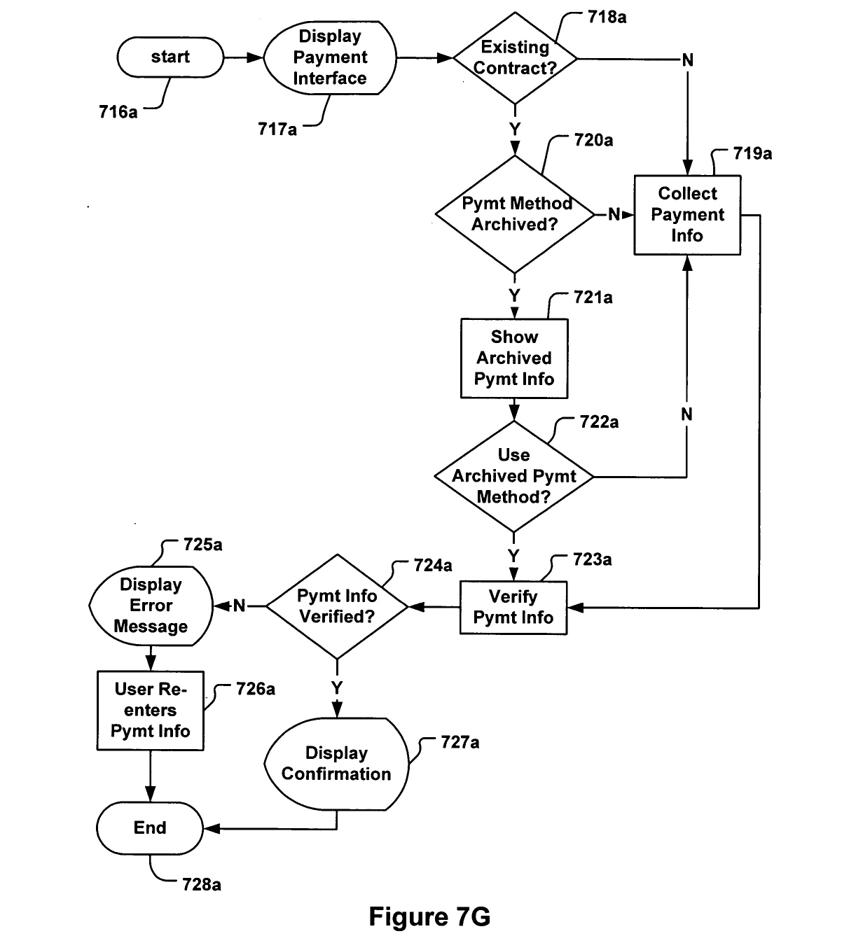

FIGS. 7-7F describe the processing performed by the business directory listing registration system 300 of FIG. 3 to procure, maintain, and manage business listings and advertisements from participating users. FIG. 7 describes the overall processing contemplated by electronic business directory listing registration system 300. Processing starts at block 700 and proceeds to block 701 where a check is performed to determine whether the participating user already has a business listing stored with the registration system. If a business listing does not already exist for the participating user, processing directed to the creation of business listing contract (according to FIG. 7B), is performed at block 702. A business match (according to FIG. 7D) is then performed at block 703. Processing then proceeds to block 704 where processing directed to the creation of a business advertisement contract (according to FIG. 7C) is performed. A check is then performed at block 705 to determine if the participating user has a login account. If the participating user has a login account, the user logs in at block 707. However, if the contrary is true, an account is created for the participating user at block 706. Processing proceeds from blocks 706 and 707 to block 708 where the business listing and/or advertisement contracts are saved. The user is then prompted for payment at block 709 and processing ends at block 710.

However, if at block 701 the user already has a business listing stored in the business directory listing registration system, processing proceeds to block 711 where the user is prompted to login. The user is then queried if he/she would like to create a new contract at block 712. If the user wants to create a new contract, processing is directed to block 702 and proceeds therefrom. However, if at block 712, the user does not care to create a new contract, processing proceeds to block 713 where options relevant to updating existing business listings are displayed to the user. The user is then queried at block 714 to determine if the user wishes to create a new business listing/advertisement package or to update the current business listing/advertisement package. If the user wishes to update his/her current package processing proceeds to block 716. Alternatively, processing proceeds to block 715 where a new business listing/advertisement package is created. The business listing and/or advertisement contract is either newly created and saved or updated and saved at block 717. The registration system then prompts the user for payment at block 718 and processing then ends at block 710.

FIG. 7A describes the processing contemplated by the business directory listing and advertisement registration system when processing login information (as described by block 707 of FIG. 7). Processing starts tat block 719 and proceeds to block 720 where the registration system is launched and then to block 721 where the initial interface is rendered for display to participating users. Processing proceeds to block 722 where a check is performed to determine if the participating user has an existing contract. If the user does not have a contract, the user is processed as a first time user at block 723. Processing then proceeds to block 724 for new contract processing (according to FIG. 7B processing). However if at block 722, the user has an existing contract but does not recall their login information, processing proceeds to block 725 where the login information is reconciled. From there, a help application is rendered for display to the user and processing then ends at block 727. Alternatively, if at block 722 the user does have a contract on file, the user is prompted to login at block 728. The login information is verified at block 729. A check is then made at block 730 to determine if the credentials for the user are proper. If the credentials prove to be valid at block 730, processing proceeds to block 731 where a check is performed to determine if the user wishes to modify their existing contract. If the user wishes to do so, processing proceeds to block 732 for contract update processing (in accordance with FIG. 7B). However if the user does not want to modify the contract at block 731 but rather wishes to create a new contract, processing proceeds to block 723 and therefrom. If the alternative proves to be true at block 730, that is, the user's credentials are not valid, processing proceeds to block 733 where an error is displayed and then to block 734 to check if the user wishes to retry the login process. If the user wishes to retry processing proceeds to block 728 and therefrom. Alternatively, processing ends at block 727 if the user does not wish to retry the login.

FIG. 7B describes the processing performed by the present system when creating or updating a business listing. Processing starts at block 735 and proceeds to block 736 where information about the creation of new contracts is displayed to participating users. The user is then prompted to enter their business location data at block 737. From there, processing proceeds to block 738 where business matching processing (according to FIG. 7D) is performed. The user is then queried to determine if the user has additional listings at block 739. If the user does have additional listings processing proceeds to block 737 and therefrom. However, if the alternative proves to be true, processing proceeds to block 740 where a list of the available categories and SIC designations are displayed to the user. A check is then performed at block 741 to determine if the user wants to create a new listing. If the user wants to create a new listing, processing proceeds to block 742 where the user is prompted to select the appropriate categories and SICs. Alternatively, processing proceeds to block 746 and therefrom. A check is performed at block 743 to determine if the categories have brands. If they do have brands, the user is prompted to select the appropriate brands that go along with the chosen categories at block 744. The user is then prompted to select the extended attributes of the chosen branded categories at block 745. However, if at block 743 the categories do not have brands, processing proceeds to block 745 and therefrom. From block 745 processing proceeds to block 746 where a check is performed to determine if the user wants to update the newly created or existing listing at block 746. If the user wants to update an existing listing the listing attributes are displayed to the user at block 747 and the user is then prompted to accept of modify each of the listing's attributes at block 748. Processing then proceeds to block 749 where advertisement contract processing is performed (according to FIG. 7C). If, however, the user does not wish to update the existing contract at block 746, processing proceeds to block 749.

FIG. 7C describes the processing performed when creating or updating an advertisement package to be associated with a business listing. Processing starts at block 750 and proceeds to block 752 where advertisement package descriptions and pricing information is displayed to participating users. The user is then prompted to select desired parent and child advertisement packages at block 753. A determination is then made at block 754 to ascertain the maximum number of lines that may be allowed in the advertisement. The user is then prompted to input their text lines for their advertisements at block 755. Processing proceeds to block 756 where the user is prompted to select a background color for the advertisement. Additionally the user is prompted for his/her e-mail information at block 757. The user then uploads their logo file to act as a hyper-link to their content at block 758. A check is then performed at block 759 to determine if the advertisement package chosen contains a Website. If the package does not contain a Website, processing proceeds to block 775 and therefrom. However if there is a Website included in the chosen advertisement package, processing proceeds to block 760 to determine if the Website is an internal Website. If it is not an internal Website processing proceeds to block 761 where the user is prompted to input a URL for the Website. Processing proceeds to block 764 and therefrom. However, if it is determined at block 760 that the included Website is to be an internal Website, processing proceeds to block 762 where the user is prompted to enter a friendly name. Generally, a friendly name is an alias to better identify the inputted URL. The user is then prompted to create a Website at block 763. Processing proceeds to block 764 where a check is performed to determine if the chosen advertisement package contains graphic image tiles. If the packages do not contain tiles at block 764 processing proceeds to block 769 and therefrom. However, if the advertisement packages do contain graphic image tiles at block 764, processing proceeds to block 765 user is prompted to select tile attributes for each of the tiles. The user is then prompted to load appropriate image files for the tiles at block 767. A check is then performed at block 767 to determine if the chosen advertisement packages contemplate tiles displayed according to a national in scope. If they are, processing proceeds to block 771 where the user selects the rotation scope of the advertisements. Alternatively, if the chosen advertisement packages do not have a national scope, the tile is given a scope at block 770. A check is then performed at block 769 to determine if the chosen advertisement packages contain graphical image banners. If they do not, processing proceeds to block 775 and therefrom. However, if the alternative proves to be true, the user is prompted to select graphical image banner attributes at block 768. The user then uploads image files for the banners at block 772. A check is then performed at block 773 to determine if the chosen advertisement package has a national scope for the display of the banners. If they are national banners, the user is prompted to select the rotation scope for the banners at block 774. The rotation scope defines how often and in which geographic portions the banners are to be displayed. If the alternative proves to be true, that is, the banners do hot have a national scope the banners are provided with a scope at block 776. Processing proceeds to block 775 where the user is prompted to enter relevant contract information. From there payment is processed (according to FIG. 7F).

FIG. 7D describes the processing performed by the business directory listing registration system when matching a business name with an archived listing. Processing begins at block 778 and proceeds to block 779 where a business entry page is rendered. The user is then prompted to enter business location information at block 780. At that time, a business match code is determined at block 781. A check is then performed at block 782 to determine if a match was found between the inputted business location information and the stored business listings. If more than one match is found, processing proceeds to block 783 where the matched business locations are displayed to the user. The user is then prompted at block 784 to select the businesses with which he/she wishes to associate advertisements. A check is then performed at block 785 to determine if at least one business was chosen. If no businesses were chosen at block 784, processing proceeds to block 789 and therefrom. However, if the alternative proves to be true a business ID is set at block 786. A check is then performed at block 787 to determine if the business information stored for the chosen business is correct. If the business information is correct processing ends at block 788. However, if the user wishes to update the information on file, a business form having the fields pre-populated with the business information is displayed to the user at block 789. The user selects to update the business information at block 790 and the information is saved at block 791. Processing then proceeds to end at block 788. If however, at block 782 there are no matches found to the entered business location information inputted at block 780, processing proceeds to block 794 where the user is prompted with a message indicating a new business listing needs to created. Processing proceeds to block 789 where the business is inserted as new. Processing then terminates at block 788.

FIG. 7E better describes the processing performed when executing a search for existing business entities, i.e., business matching processing of block 782 of FIG. 7D. A stored business may be found according to three different searches. These searches include a “SourceMap” search, a “Phone” search, and a “Bounded” search. During a “SourceMap” search, a query is performed on the cooperating data store using an inputted SourceMap ID to determine if there are any business listings having the inputted SourceMap ID. A SourceMap ID is a unique identifier that is stored with the business listing that is generated by the originator of the business listing. The SourceMap ID is used to differentiate business listings by various data providers. Comparatively, business keywords (i.e., pizza restaurant) and combinations of zip code, area code and phone number are used to query a cooperating data store in a “Phone” search. The “Bounded” search generally contemplates the use of business keywords, city name, and state name when performing a query of the data store.

As shown in FIG. 7E, processing begins at block 782a and proceeds to block 782b where a check is performed to see if a SourceMap parameter has been inputted. If a SourceMap parameter is passed at block 782b, processing proceeds to block 782c where a SourceMap query is executed. The results of the search query are then passed to a participating user (not shown) at block 782d. Processing then terminates at block 782e. However, if at block 782b a SourceMap parameter has not been inputted processing proceeds to block 782f where a check is performed to determine if parameters have been inputted to initiate a Phone search. If parameters indicative of a “Phone” search have been inputted at block 782f, processing proceeds to block 782g where a “Sort Name” function is performed on the inputted parameters to sort the names of the inputted parameters. Processing proceeds to block 782h where keywords are calculated from the results of the “Sort Name” function. A query is then executed on a cooperating database at block 782i using the inputted parameters. These parameters may include phone number, area code, and keyword describing the desired business listing. A check is then performed at block 782j to determine if the query produced any results. If there are results, processing proceeds to block 782d and proceeds therefrom. However, if the query of block 782i does not produce any results processing proceeds to block 782k where a second database query is performed using a second set of parameters that may include zip code, phone number, and keyword(s). Processing then proceeds to block 782d and therefrom.

However, if at block 782f parameters indicative of a “Phone” search are not inputted, processing proceeds to block 782l where a check is performed to determine if parameters indicative of city, state, or province code have been inputted. If such parameters are not inputted processing proceeds to block 782d and therefrom. However, if the converse proves to be true, processing proceeds to block 782m where the city abbreviations are translated into more suitable names for processing. A check is then performed at block 782n to determine if the inputted city name is in one of the region tables of the cooperating database. If it is not processing is exited and an error message is displayed at block 782o. However, if the inputted city name is in a database table a list of zip codes is retrieved from the region table at block 782n and processing proceeds to block 782p a filter is created to the query to only find businesses in one of the retrieved zip codes of block 782n. A single keyword is then calculated at block 782q as a filter to find the desired business name. A check is then performed at block 782r to determine if at least one token (keyword) was generated at block 782q. An additional filter is then created at block 782s to filter the business names according to sorting name. A bounded query is then executed at block 782t using all of the created filters. Processing then proceeds to block 782d and therefrom.

FIG. 7F describes the processing performed when saving a business listing or advertisement contract. Processing begins at block 701a an proceeds to block 702a where a user submits a contract for saving. A check is then performed at block 703a to determine if a business listing needs to be created. If it does, the collected business information is inserted into business directory store at block 704a. Processing reverts back to block 702a. If, however, a business does not need to be created at block 703a, processing proceeds to block 705a where a check is performed to determine whether the business information requires update. If an update is required, the business information is updated in the business directory store at block 706a and processing then reverts to block 705a. If, however, at block 705a the business information does not require update, processing proceeds to block 707a where the business listing and advertisement contracts are stored in the business directory store at block 707a. The system then generates an advertisement ID at block 708a. The Advertisement ID may be used to associate specific advertisements to specific business listing. The advertisement data is then saved in the business directory store at block 709a. A check is then performed at block 710a to determine if there were any errors during the storage processing. If there are errors at block 710a, the errors messaged are displayed to the user at block 711a and processing then ends at block 712a. However, if the alternative proves to be true, that is, there are no errors at block 710a, a proper storage confirmation message is displayed to the user at block 713a and an e-mail confirmation is mailed at block 714a. Processing proceeds to terminate at block 712a.

FIG. 7G describes the payment processing performed. Processing begins at block 716a and proceeds to block 717a where the payment interface is displayed to the user. A check is then performed at block 718a to determine if the user has an existing contract on file. If the user does not have an existing contract, the user is prompted to enter payment information at block 719a. Processing proceeds to block 723a and therefrom. Alternatively, if at block 718a, the user did have an existing contract on file, processing proceeds to block 720a where a check is performed to determine if a payment method is archived for the user. If there is no archived payment method, processing proceeds to block 719a and therefrom. However, if the alternative is true, processing proceeds to block 721a where the archived payment information is displayed. A check is then performed at block 722a to query the user to use the archived payment information for current payment. If the user chooses alternative payment information, processing proceeds to block 719a and therefrom. If, however, the user decides to use the archived payment information, processing proceeds to block 723a where the payment information is verified. A check is then performed at block 724a to determine if the payment information was properly verified. If it is properly verified, processing proceeds to block 727a where a confirmation of payment is displayed to the user. Processing then terminates at block 728a. Alternatively, if at block 724a, the payment information is not verified, an error message is displayed to the user at block 725a. The user is then prompted to re-enter the payment information at block 726a and processing terminates at block 728a.

In sum, the present invention provides a system and process for providing systems and methods for the electronic registration of business directory listings and advertisements, allowing participating users significant control over the categorization and classification of the business listings and advertisements for storage in a cooperating business directory listing data store. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer systems. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

Although exemplary embodiments of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention construed in breadth and scope in accordance with the appended claims.

What is claimed:

1. An Internet-based method for the registration of business directory listings and advertisements, comprising the following acts:
(a) providing a Web site having a user interface (UI), wherein the UI includes dialog fields for the entry of business directory listing data in accordance to predefined categories;
(b) receiving at the Web site at least one input indicative of business listing and/or advertisement information, said input indicating preferred category information for said business directory listing and/or advertisement in accordance with predefined categories offered by said Web site; and
(c) formatting said input by said Web site to create business listings having predefined categorizations.

2. The method recited in claim 1, wherein said Web site resides on a server computer in communication with the Internet, said server computer running a computing application to receive and process said at least one input.

3. The method recited in claim 1, wherein said dialog fields comprise a set of fields listing business categories for association with inputted business directory listing information.

4. The method recited in claim 3, wherein said user interface cooperates with a business directory listing data store to retrieve said business categories, said business categories indicative of editorial nodes of a business data taxonomy tree.

5. A computer-readable medium bearing computer-readable instructions for instructing a computer to carry out the steps recited in claim 1.

6. A package of business listing data generated in accordance with the following acts:
(a) providing a server computer in communication with the Internet;
(b) receiving input from a user by way of the Internet, said input providing a parameter indicative of a request for the creation of business listings and advertisements for storage in a business directory;
(c) retrieving selected instructions for the creation of said business listings and advertisements from a cooperating computing application wherein said instructions are selected based upon the parameter input the user input; and
(d) generating said package of business listing data as a function of said computer application instructions.

7. The method recited in claim 6, wherein said parameter comprises preferred business categories for the categorization of the generated package of business listing data.

8. The method recited in claim 7, wherein said preferred business categories comprise editorial nodes of a business data taxonomy tree, said business data taxonomy tree residing on a cooperating data store.

9. A computer-readable medium bearing computer-readable instructions for instructing a computer to carry out the steps recited in claim 6.
